(19) United States
(12) Patent Application Publication
(10) Pub. No.: US 2020/0231502 A1
(43) Pub. Date: Jul. 23, 2020

(54) LIGHTWEIGHT CONCRETE

(71) Applicant: MATRIX COMPOSITES & ENGINEERING LTD, Henderson, Western Australia (AU)

(72) Inventor: Gary Charles Strickland, Perth (AU)

(21) Appl. No.: 16/330,607

(22) PCT Filed: Sep. 5, 2017
(86) PCT No.: PCT/AU2017/050962

§ 371 Date: Mar. 5, 2019

(30) Foreign Application Priority Data
Sep. 5, 2016 (AU) 2016903560

(51) Int. Cl. C04B 28/04

(52) U.S. Cl. CPC C04B 28/04; C04B 2103/30

(57) ABSTRACT

The present disclosure relates to a cement or concrete composition comprising a hydraulic binder, a water reducing plasticiser, a rheological additive, and composite spheres for lowering the density of the composition, wherein the composite spheres comprise a core having one or more coating layers thereon.

### TECHNICAL FIELD

The technical disclosure relates to a cement or concrete composition, lightweight concrete material, and a method of making the material, in particular for buoyancy and construction applications.

### BACKGROUND

Hydraulic cement formulations that set and harden irreversibly in the presence of water are well known.

Normal weight concrete material has found considerable application in energy-related offshore structures, such as oil drilling and production platforms. It is often desirable to utilise concrete material that is lower in unit weight than normal weight concrete, in particular for buoyancy applications.

Lightweight concrete material often suffers from the drawback that the lightweight aggregates within the hydraulic cement formulations such as natural sands, gravels, and crushed stones are highly water absorbent. Consequently, these lightweight concrete material designs present a problem when applied to buoyancy applications, such as buoyancy tanks, floating pontoons and floating walkways, because seawater permeates through the Portland cement binder and eventually fills the voids within the aggregate particles. As such, the unit weight of the concrete material changes with time which is undesirable because the actual buoyancy of the structure at any given time is not known with certainty.

Another problem with regular lightweight concrete material is that the strength of the material is often limited by the strength of the aggregate particles mixed within the cement formulation.

There is a need to provide alternative cement compositions and light weight concrete materials that address any one or more problems of currently available cement compositions and concrete materials, in particular for buoyancy and construction applications.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

The present disclosure provides cement and lightweight concrete compositions suitable for buoyancy applications and construction applications. The cement compositions, concrete compositions and concrete materials comprise composite spheres that are incorporated to lower the density of the concrete material.

In a first aspect, there is provided a cement or concrete composition comprising a hydraulic binder, a water reducing plasticiser, a rheological additive, and composite spheres for lowering the density of the composition. The composite spheres comprise a core having one or more coating layers thereon. Each of the one or more coating layers may be independently selected from at least one of a fibre layer, aggregate layer and cement layer. It will be appreciated that when two or more coating layers are present, then the various coating layers may be of the same type or of different types and configurations.

Each of the one or more coating layers may comprise a polymer and at least one of a fibre, aggregate and cement material. The fibre layer may comprise a polymer and fibres, such as at least one of fibreglass fibres, carbon fibres and mineral fibres. The aggregate layer may comprise a polymer and aggregate, such as silica sand. The cement layer may comprise a polymer and a cement, such as Portland cement. The polymer in the coating layers may be a resin, such as an epoxy resin and optionally a hardener, for example an amine hardener.

In an embodiment, the composite spheres each comprise one or more coating layers comprising at least one fibre layer. In another embodiment, the composite spheres each comprise two or more coating layers selected from a fibre layer and at least one of an aggregate layer and cement layer. The cement layer may be a Portland cement layer. In another embodiment, the composite spheres each comprise three or more coating layers comprising at least one fibre layer, aggregate layer and cement layer.

In an embodiment, the composite spheres comprise a polymer core and each coating layer comprises an epoxy resin and fibres. The fibres may be selected from at least one of fibreglass fibre, carbon fibre or mineral fibre.

The cement or concrete composition may be provided as a dry blend formulation, for example an aggregate formulation for use in preparing a light weight concrete material.

In a second aspect, there is provided a concrete material comprising the composition or an admixture of the composition of the above first aspect (or any embodiments or examples thereof as described herein) and water.

In a third aspect, there is provided a concrete material being a product prepared from the composition or an admixture of the composition of the above first aspect (or any embodiments or examples thereof as described herein) and water.

In an embodiment of the second or third aspect, the concrete material comprises ceramic microspheres and optionally a fine aggregate material, and the density of the concrete is between 600 kg/m³ to 1800 kg/m³.

In another embodiment of the second or third aspect, the concrete material comprises glass microspheres and the density of the concrete material is between 300 kg/m³ to 800 kg/m³.

In a forth aspect, there is provided a plurality of composite spheres, wherein each of the composite spheres comprises a core having one or more coating layers thereon, and wherein each of the one or more coating layers on an individual composite sphere is independently selected from at least one of a fibre layer, aggregate layer and cement layer.

Each of the one or more coating layers on a composite sphere may comprise a polymer and at least one of a fibre, aggregate and cement. Each composite sphere may have two or more coating layers, for example at least three or at least four coating layers. The plurality of composite spheres may be selected so that the individual composite spheres each have the same coating layer(s) or same configuration of coating layer(s). The coating layers or configuration of coating layers may be the same or different between individual composite spheres, for example the plurality of composite spheres may be substantially uniform or may be provided by a mixture of different types of composite spheres.

The fibre layer may comprise a polymer and fibre. The aggregate layer may comprise a polymer and aggregate. The cement layer may comprise a polymer and cement, such as Portland cement. The polymer may be a resin, such as an epoxy resin and optionally a hardener, for example an amine hardener.

In an embodiment, the composite spheres each comprise one or more coating layers comprising at least one fibre layer. In another embodiment, the composite spheres each comprise two or more coating layers selected from a fibre layer and at least one of an aggregate layer and cement layer. In another embodiment, the composite spheres each comprise three or more coating layers comprising at least one fibre layer, aggregate layer and cement layer. The fibre layer may be provided as a first layer and optionally as an intervening layer between the aggregate layer and cement layer when both those layers are present.

In one embodiment, the composite spheres each comprise at least four coatings wherein one or more first coating layer(s) is a fibre layer, one or more second coating layers is an aggregate layer, one or more third coating layers is a fibre layer, and one or more forth coating layers is a cement layer.

In a fifth aspect, there is provided a use of composite spheres in a cement or concrete composition for lowering the density of a concrete material prepared therefrom, wherein the composite spheres are provided according to any embodiments or examples thereof as described herein.

In a sixth aspect, there is provided a method of preparing a cement or concrete composition comprising admixing together, in any order, a hydraulic binder, a water reducing plasticiser, a rheological additive, and composite spheres are provided according to any embodiments or examples thereof as described herein.

In one embodiment, the method is for preparing a dry-blend formulation, for example a dry-blend aggregate formulation for use in preparing a light-weight concrete material.

In a seventh aspect, there is provided a method of preparing a concrete material comprising incorporating composite spheres into a cement formulation and forming a concrete material, wherein the composite spheres are provided according to any embodiments or examples thereof as described herein.

In an eighth aspect, there is provided a method of preparing a concrete material comprising incorporating composite spheres into a cement formulation, adding water to the cement formulation to form a slurry, and curing the slurry to form a concrete material, wherein the composite spheres are provided according to any embodiments or examples thereof as described herein.

In an ninth aspect, there is provided a method of forming a concrete material, the method comprising mixing the composition according to the above first aspect with water to form a slurry, and allowing the slurry to cure into a concrete material.

In an embodiment of the eighth or ninth aspect, the method further comprises introducing the slurry into a mould to form a green shaped article, removing the mould from the green shaped article, and curing the green shaped article to form the concrete material.

In a tenth aspect, there is provided a method of forming a concrete material, the method comprising:

mixing at least a hydraulic binder, a water reducing plasticiser, a rheological additive and water to create a slurry;

providing a mould;

filling the mould at least partially with composite spheres, wherein the composite spheres are provided according to any embodiments or examples thereof as described herein;

introducing the slurry into the mould that is at least partially filed with the composite spheres to form a green shaped article;

removing the mould from the green shaped article; and

curing the green shaped article to form the concrete material.

Other exemplary embodiments (e.g., composite spheres, compositions, concrete material and associated methods etc.) are described below. The features, functions, and advantages that have been discussed can be achieved independently in various embodiments or may be combined in yet other embodiments further details of which can be seen with reference to the following description and drawings.

### BRIEF DESCRIPTION OF DRAWINGS

Exemplary embodiments of the present disclosure are more fully described in the following description. This description is included solely for the purposes of exemplifying embodiments of the present disclosure. It should not be understood as a restriction on the broad summary, disclosure or description of the present disclosure as set out above. The description will be made with reference to the accompanying drawings, by way of example only, in which:

FIG. 1 is a schematic perspective view of a cement composition for lightweight concrete material in accordance with one example or first embodiment of the present disclosure;

FIG. 2 is a schematic perspective view of a cement composition for lightweight concrete material in accordance with another example or second embodiment of the present disclosure;

FIG. 3 shows a flow chart illustrating a method of making a cement composition for lightweight concrete material in accordance with some examples or embodiments of the present disclosure;

FIG. 4 shows a flow chart illustrating a further method of making a cement composition for lightweight concrete material in accordance with some examples or embodiments of the present disclosure;

FIGS. 5A and 5B show a composite sphere for lightweight concrete material in accordance with some examples or embodiments of the present disclosure;

FIGS. 6A-D show composite spheres with various coating layers and configurations for lightweight concrete materials in accordance with some examples or embodiments of the present disclosure.

### DESCRIPTION OF EMBODIMENTS

Some embodiments of the present disclosure describe a cement or concrete composition and lightweight concrete material that is particularly suitable for buoyancy applications and construction applications. Each of the embodiments described in the following incorporates a cement or concrete composition comprising composite spheres that are incorporated into the composition to lower the density of the concrete material. Exemplary applications for the described lightweight concrete material include: sub-sea buoyancy applications, installation buoyancy applications, such as floating pontoons and floating walkways, and construction applications such as lightweight panel structures, energy absorbing materials, fire retardant panel structures, sound dampening panels and structures, thermally insulating panels and structures, panels and flooring for floating houses.

The described embodiments may further comprise glass spheres and/or ceramic spheres to further lower the density of the concrete material.

### First Embodiment—A Lightweight Concrete Material Suited for Buoyancy Applications

A first embodiment of the present disclosure relates to a cement or concrete composition for a lightweight concrete material comprising composite spheres and optionally glass microspheres. In a particular embodiment, the cement or concrete compositions comprise composite spheres and glass microspheres. The resulting concrete material is particularly suited for sub-sea buoyancy and floating pontoon structures for reasons illustrated in detail below. In a particular embodiment, the concrete material is a lightweight material having a density in a range of 300 kg/m³ to 800 kg/m³. For example, the density of the concrete material may be less than 700 kg/m³, or less than 600 kg/m³, or less than 500 kg/m³, or about 400 kg/m³. The density of the lightweight concrete material may depend on the application of the concrete material. For example, a concrete material with a density of approximately 400 kg/m³ may only be operable up to a depth of 600 m under water, whereas a concrete material with a density of 800 kg/m³ may be operable at depths up to 2000 m.

The cement or concrete composition typically comprises a hydraulic binder, a water reducing plasticiser and a rheological additive.

The hydraulic binder typically is a finely ground inorganic material that forms a paste when mixed with water and hardens by means of hydration. The hydraulic binder may be a pozzolan material, for example Portland cement, such as GP cement. The hydraulic binder may be selected from the group consisting of calcium sulpho aluminate cement with anhydrous calcium sulphate, granulated blast furnace cement and marine cement. Examples of suitable cements may include rapid hardening cement (or) high early strength cement, extra rapid hardening cement, sulphate resisting cement, quick setting cement, low heat cement, portland pozzolanic cement, portland slag cement, high alumina cement, air entraining cement, super sulphated cement, masonry cement, expansive cement, coloured cement, and white cement.

By adding the hydraulic binder into the concrete compound material, the composite spheres and optionally the glass microspheres can be incorporated to provide sufficient strength to the material.

The water reducing plasticiser is typically added to the cement or concrete composition to reduce the water needed in the composition. By adding the water reducing plasticiser, overall strength of the concrete material may be increased and the porosity of the material may be reduced. Exemplary water reducing plasticiser used for this embodiment may include, but are not limited to, polycarboxylates, melamine formaldehyde sulfonates and polynaphthalene sulfonates. These exemplary water reducing plasticisers relate to high range water reducers that may reduce the amount of water needed for the formulation by approximately 12% to 30%. In some embodiments, the cement or concrete composition comprises less than 1.5% by weight of the high range water reducers, such as polycarboxylates. For example, the cement or concrete composition may comprise less than 1%, or less than 0.8% or approximately 0.6% by weight of the high range water reducer.

It will be appreciated that low range water reducing plasticiser may alternatively be used as a water reducing plasticiser, which typically reduce the amount of water needed for the composition by approximately 5% to 10%. An example of a low range water reducing plasticiser is sodium lignosulphonate. In some embodiments, the cement or concrete composition may comprise less than 2% by weight of the low range water reducers. However, it will be appreciated that the cement or concrete composition may comprise less than 1.5%, or less than 1.2% or approximately 1% by weight of the low range water reducers.

The rheological additive is typically added to the cement or concrete composition to reduce the risk of segregation or separation of the lower and higher density components in the concrete material. As such, a higher uniformity of the resulting concrete material may be achieved by adding the rheological additive. Exemplary rheological additive added to the cement or concrete composition for embodiments of the present disclosure may include but are not limited to hydroxyethyl cellulose derivatives, methyl cellulose derivatives, Guar derivates and Xanthan derivatives. In one particular embodiment, the rheological additive added to the cement or concrete composition is hydroxyethyl cellulose derivatives such as the Natrosol™ (ASHLAND chemicals) range of additives of grades 250 type. The hydroxyethyl cellulose derivatives may be added at less than 1% by weight, or less than 0.8% by weight, or less than 0.5% by weight, or less than 0.4% by weight, or less than 0.3% by weight, or less than 0.2% by weight or approximately 0.1% by weight.

In addition, other additives may be added to the cement or concrete composition to further lower the density of the concrete material and/or improve other properties of the resulting material, such as overall strength, and porosity. Other additives may include, but are not limited to natural and artificial pozzolanic materials, cement antifoam and re-dispersible polymer powders. Pozzolanic materials are typically added to the formulation to increase the overall strength of the concrete material and may include silica fume, fly ash and/or Super-Pozz. Defoamers or anti-foaming agents typically allow any air entrained or generated in mixing the material to be released. As such, porosity of the resulting material may be achieved which results in an increased strength of the material. Exemplary defoamers or anti-foaming agents may include but are not limited to insoluble oils, polydimethylsiloxanes and other silicones, alcohols, stearates and glycols. Re-dispersible polymer powders are typically added to the formulation to increase the bond between at least the hydraulic binder and the hollow composite spheres. As such, by adding a re-dispersible polymer powder to the material, the overall mechanical and hydrostatic strength of the concrete material may be increased. In addition, the young's modulus of the material may be reduced and the mechanical elongation properties of the material may be increased thereby increasing the overall toughness of the concrete material. Furthermore, by adding a re-dispersible polymer powder, porosity of the resulting material may be decreased thereby increasing the hydrostatic performance of the material in immersed conditions.

In the embodiments described below, the composite spheres comprise a core having one or more coating layers thereon.

### Composite Spheres

The composite spheres each comprise a core having one or more coating layers thereon, and wherein each of the one or more coating layers on an individual composite sphere may be independently selected from at least one of a fibre layer, aggregate layer and cement layer.

Each of the one or more coating layers on a composite sphere may comprise a polymer and at least one of a fibre, aggregate and cement. Each composite sphere may have two or more coating layers, for example at least three or at least four coating layers. The plurality of composite spheres may be selected so that the individual composite spheres each have the same configuration of coating layer(s). The coating layers may be the same or different for an individual composite sphere. Any one or more of the coating layers may partially or fully coat the surface of the core or a previous coating layer thereof.

The fibre layer may comprise a polymer and fibre. The aggregate layer may comprise a polymer and aggregate. The cement layer may comprise a polymer and a cement. For example, each of the one or more coating layers may comprise a polymer and at least one of a fibre, aggregate and cement. It will be appreciated that the fibre, aggregate or cement may be generally distributed in the coating layer, although may not necessarily be uniformly or homogeneously distributed therein. For example, the aggregate layer may provide a lumpy coating that may further enhance physical adhesion. An outer layer, for example a cement layer, may also further enhance adhesion in the composition or formed concrete material, which may be via chemical and/or physical association or reaction.

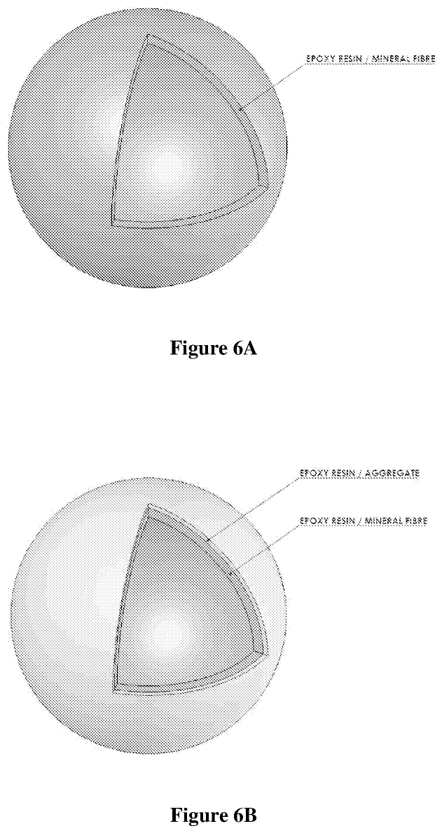

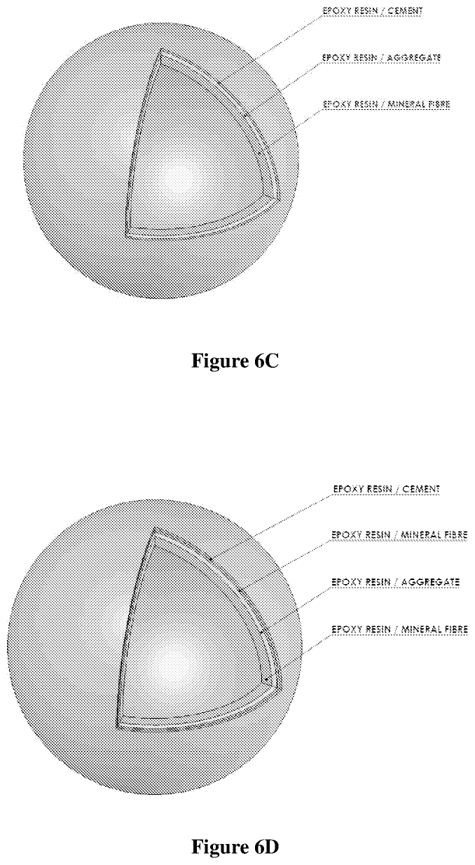

In an embodiment, the composite spheres each comprise one or more coating layers comprising at least one fibre layer. In another embodiment, the composite spheres each comprise two or more coating layers selected from a fibre layer and at least one of an aggregate layer and cement layer. In another embodiment, the composite spheres each comprise three or more coating layers comprising at least one fibre layer, aggregate layer and cement layer. FIGS. 6A-D show various configurations in the coating layers for an individual composite sphere. FIG. 6A shows a composite sphere having a fibre layer only. FIG. 6B shows a composite sphere having a first layer being a fibre layer and a second layer being an aggregate layer. FIG. 6C shows a composite sphere having a first layer being a fibre layer, a second layer being an aggregate layer, and a third (outer) layer being a cement layer. FIG. 6D shows a composite sphere having a first layer being a fibre layer, a second layer being an aggregate layer, a third layer being a fibre layer, and a forth (outer) layer being a cement layer. Each of the individual layers shown in FIGS. 6A-D may be provided by one or more layers of that same type.

In an embodiment, the composite spheres each comprise one or more coating layers on the core wherein at least a first coating layer is a fibre layer, for example a coating layer comprising a polymer and fibre. In another embodiment, the composite spheres each comprise two or more coating layers wherein at least a first coating layer is a fibre layer and a further coating layer comprises at least one of an aggregate layer and cement layer. In another embodiment, the composite spheres each comprise three or more coating layers wherein at least a first coating layer is a fibre layer and further coating layers comprise an aggregate layer and a cement layer. In another embodiment, the composite spheres each comprise three or more coating layers wherein at least a first coating layer comprises one or more fibre layer(s) and a second coating layer comprises one or more aggregate layer(s) and a third coating layer comprises one or more cement layer(s). The polymer may be an epoxy resin. Each of the fibre layer, aggregate layer and cement layer may be provided as one or more adjacent layers or as intervening layers between each other. The fibre layer may be provided as an intervening layer between the aggregate layer and cement layer. The outer layer of the composite spheres may be an aggregate layer or cement layer. The configuration of the layers, including outer layer selection (e.g. aggregate layer or cement layer) can provide further advantages including compatibility, dispersion or adhesion with the composition, at least according to some embodiments or examples as described herein.

For the composite spheres, each type of coating layer may be provided as a single layer or as multiple layers on the core. For example, the individual coating layers on the core may provide 1 to 60 layers, 1 to 40 layers or 20 to 40 layers. The number of coating layers of the same or different layer type may be at least 2, 3, 4, 5, 6, 7, 8, 9, 10, 15, 20, 25, 30, or 35. For example, where the fibre layer is the first coating layer on the core it may be individually provided as 1 to 60 layers, 1 to 40 layers or 20 to 40 layers. It will be appreciated that other layer types (e.g. aggregate layer or cement layer) may then be provided as single or multiple layers thereon. Each individual layer may be about 20 to 200 μm, for example (in μm) 30 to 150, 40 to 100, or 50 to 80.

In one embodiment, the composite spheres each comprise at least three types of coating layers. For example, the one or more first coating layer(s) is a fibre layer, one or more second coating layers is an aggregate layer, one or more third coating layers is a fibre layer, and one or more forth coating layers is a cement layer. For example, the outer layer may be a cement layer. The selection of the outer layer can provide further advantages with adhesion and compatibility in the cement composition and material.

The core of the composite spheres may, for example, be a polymer core such as an expanded or foamed polymer. The core may be substantially hollow or porous, for example having a porosity (in % of void volume) of at least 10, 20, 30, 40, 50, 60, 70, 80, or 90. The bulk density (in kg/m³) of the core may be less than about 50, 40, 30, 20, 10, 9, 8, 7, 6, 5, 4, 3, 2, or 1. Other suitable cores may comprise a cement or geopolymer core, an open cell polyurethane core or syntactic foam core. In one particular example, the core comprises a polystyrene core. However, it will be appreciated by a person skilled in the art that any suitable material is envisaged for the core of the composite spheres. The material of the core may be selected to provide the composite spheres with a lightweight and/or low density. Other properties that may be affected by the selection of the core material relate to thermal insulation and sound insulation. The core may be substantially hollow, such as provided by a foam and comprising voids or porosity. The core may comprise a polymer coating, for example a coating of an epoxy resin and optionally a hardener, for example an amine hardener.

As mentioned above, each coating layer may comprise a polymer. The polymer may for example include thermoset polymers and/or thermoplastic polymers. In one particular example, the coating layer of the composite spheres comprises epoxy resin. The coating layer may further comprise an amine curative or hardener. In a further example, the polymer may comprise plastics, such as synthetic or semi-synthetic organic compounds.

In the fibre layer, the fibres may comprise any suitable fibres, such as milled glass fibre, carbon fibre and/or mineral fibre, such as wollastonite. A specific exemplary composition of the composite spheres that may be used for the present disclosure will be described in detail below.

By adding the composite spheres into the cement or concrete composition, the density of the concrete material can be lowered and the overall strength of the material can be increased. Furthermore, at least some of the composite spheres used for the embodiments described herein are substantially impervious to water and to hydrostatic pressure. As such, adding the composite spheres to the material has the significant advantage that the concrete material becomes particularly suitable for aqueous conditions, both in subsea and surface applications.

As mentioned above, in one particular example the composite spheres comprise a polymer core having one or more coating layers thereon. The coating layer may comprise the coating layers or configurations as described above. The coating of the composite spheres may comprise an amine curative. As mentioned above, exemplary fibre may include, but is not limited to mineral, glass and carbon fibre. The fibre for the present embodiments typically have an aspect ratio (defined as the ratio of fibre length to diameter) greater than 10:1 and a mean fibre length between approximately 1 micron to 500 microns. Exemplary epoxy resin may include, but is not limited to bisphenonol A diglycidyl ether resin, bisphenol F diglycidyl ether resin, epoxy phenyl novolac resin, aliphatic epoxy resin and glycidylamine epoxy resin. Exemplary amine curative may include but is not limited to aliphatic amines, cycloaliphatic amines, polyamides and amidomines.

The aggregate coating layer may comprise an aggregate selected from zeolites quartzite, cherts, sandstones, quartz sand, granites, syenites, andesite, basalt, limestones marbles, dolomites, expanded shale clay, slate, expanded slag, blast furnace slag, pumice perlite, vermiculite, barite, calcite, and magnetite. In one example, the aggregate is a silica sand. The aggregate may have an average particle size between about 100 micron and 5 mm, for example 500 micron to 3 mm, 800 micron to 2 mm, or 1 mm to 1.5 mm.

The cement coating layer may comprise a cement capable of hardening on contact with water. The cement may be selected from rapid hardening cement (or) high early strength cement, extra rapid hardening cement, sulphate resisting cement, quick setting cement, low heat cement, portland pozzolanic cement, portland slag cement high alumina cement, air entraining cement super sulphated cement, masonry cement, expansive cement, coloured cement, white cement, or any combination thereof. In one example, the cement is Portland cement.

An exemplary composition of the composite spheres may comprise (by weight) 20-70% fibre, 10-60% epoxy resin, 2-20% amine curative, 0.2-15% expanded polystyrene and 0-5% wetting/additives.

Typical sizes of the composite spheres used in the embodiments described in the present disclosure range from 1 mm diameter to 100 mm diameter. For example, the diameter of the composite spheres may be less than 100 mm, about 90 mm, about 75 mm, about 50 mm, about 25 mm, about 10 mm, about 5 mm or about 1 mm.

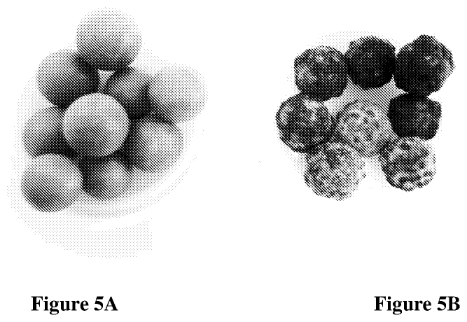

One particular formulation of composite spheres include (by weight) and is shown in FIG. 5A:

| | |
|---|---|
| Wollastonite fibre | 55% |
| Epoxy resin | 32% |
| Amine curative | 4% |
| 10 mm expanded polystyrene ball | 9% |

As previously mentioned, the particular formulation of composite spheres discussed above may further comprise additional coating layers. As seen in FIG. 5, a fibre reinforced composite sphere discussed above may have a smooth outer surface (FIG. 5A), whereas a fibre reinforced composite sphere further coated with a coarse aggregate layer and/or cement layer, wherein each additional layer has been bound to the composite sphere with epoxy resin/amine curative, may have a rough outer surface (FIG. 5B), which can provide further advantages for further enhancing adhering of the composite spheres with the cement composition.

One exemplary method of making the composite spheres include the following steps: initially the spherical expanded polystyrene balls are coated with thermoset epoxy resin blend that comprises epoxy resin and amine curative. Following coating of the polystyrene balls with the thermoset epoxy resin blend, the fibres are distributed onto the expanded polystyrene balls such that the fibres are embedded into the surface of the hardening thermoset resin. The resin blend is then allowed to cure or harden to a substantially solid state.

The curing process may or may not be accelerated by heat. Subsequent coats of resin and fibres may be added onto the expanded polystyrene ball in order to manufacture a stronger, higher density sphere. Additives to aid adhesion between the fibre and resin may also be added at any stage during the manufacture process.

As mentioned above, the lightweight concrete material of the first embodiment of the present disclosure may further comprise glass microspheres.

The glass microspheres are typically mixed into the cement or concrete composition described above. The glass microspheres in this particular embodiment are added to the cement or concrete composition to further reduce the density of the concrete material. In addition, the glass microspheres may improve the overall strength of the concrete material.

Glass microspheres are typically impervious to water and hydrostatic pressure (depending on the spheres grade) which makes the glass microspheres particularly suitable for aqueous applications, including subsea and surface applications. By adding glass microspheres to the lightweight concrete material, durability of the material in those applications may be significantly improved.

Exemplary glass microspheres added to the cement or concrete composition for embodiments of the present disclosure may include but are not limited to glass bubbles made of synthetic material manufactured from a glass frit material. The glass microspheres that are used in the described first embodiment, but not limited to, may have a diameter less than 200 microns, about 150 microns, about 100 microns, about 50 microns, about 10 microns, or about 5 microns. The glass microspheres used in the first embodiment may have a density less than 800 kg/m³, about 700 kg/m³, about 600 kg/m³, about 500 kg/m³, about 400 kg/m³, about 300 kg/m³, about 200 kg/m³, or about 100 kg/m³. Glass microspheres are, for example, commercially available from 3M, Potters industries and Sinosteel China.

An exemplary composition of the concrete material of the first embodiment of the present disclosure includes approximately (by volume) 40-65% composite spheres, 5-30% glass microspheres, 5-50% hydraulic binder, 0.05-3% cement water reducer, and 0.05-3% rheological additive.

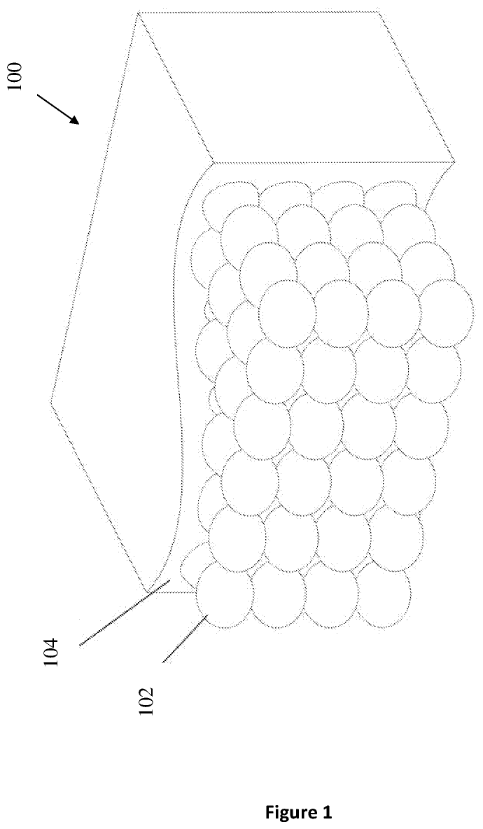

In a first variation of the first embodiment, all of the incorporated composite spheres have substantially uniform size and composition. This type of concrete material may also be referred to as mono composite spheres light weight concrete material. A schematic perspective view of this type of concrete material 100 is shown in FIG. 1. The material 100 comprises composite spheres 102 of substantially one diameter and a cement formulation 104 that incorporates the hollow composite spheres 102. In this particular example as illustrated in FIG. 1, the cement formulation 104 comprises a hydraulic binder, glass microspheres, cement water reducer and a rheological additive.

An exemplary composition of a mono composite spheres light weight concrete material includes approximately (by volume) 40-65% composite spheres having a diameter of approximately 10 mm, 5-30% glass microspheres, 5-50% hydraulic binder, 0.05-3% cement water reducer and 0.05-3% rheological additive.

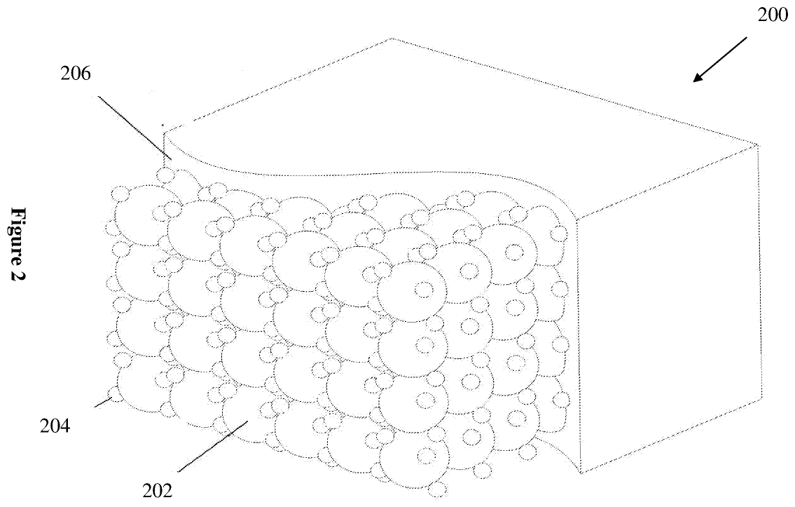

In a second variation of the first embodiment, the composite spheres that are incorporated within the cementitious formulation are spheres of two different compositions and/or sizes. This type of concrete material may also be referred to as binary composite sphere light weight concrete material. A schematic perspective view of this type of concrete material 200 is shown in FIG. 2. The material 200 comprises a first type of composite spheres 202, each having a first diameter, and a second type of composite spheres 204, each having a second diameter that is different to the first diameter. The composite spheres 202, 204 of both types are incorporated within a cement formulation 206. In this particular example as illustrated in FIG. 2, the cement formulation 206 comprises a hydraulic binder, glass microspheres, cement water reducer and a rheological additive.

The composite spheres in the concrete composition or concrete material may be between 1 mm and 100 mm, or between 2 mm and 50 mm. The composition or material may comprises at least a first and second type of composite spheres each having different size ranges. The first type of composite spheres may have a diameter of between 25 to 100 mm, for example. The second type of composite spheres may have a diameter of 1 to 10 mm, for example. A diameter ratio may be provided between the larger composite spheres relative to the smaller composite spheres of between 4:1 and 30:1, such as greater than 5:1, greater than 6:1, greater than 8:1, greater than 10:1, and/or less than 20:1, or less than 15:1. A r volume ratio may be provided between the first type of composite spheres and second type of composite spheres being between 1:1 to 6:1, such as less than 4:1, such as between 2:1 and 3.5:1.

The overall sphere volume in the concrete composition or material of the binary composite sphere light weight concrete material may occupy 40-85% of the overall volume of the concrete material (see FIG. 2). This may provide the advantage that this type of concrete material can contain a higher amount of lightweight filler material when compared to the mono composite spheres light weight concrete material and hence a lower density material can be achieved.

An exemplary composition of a binary composite sphere light weight concrete material includes approximately (by volume) 30-50% composite spheres having a diameter of approximately 50 mm, 10-30% composite spheres having a diameter of approximately 3 mm, 5-30% glass microspheres, 5-50% hydraulic binder, 0.05-3% cement water reducer and 0.05-3% rheological additive.

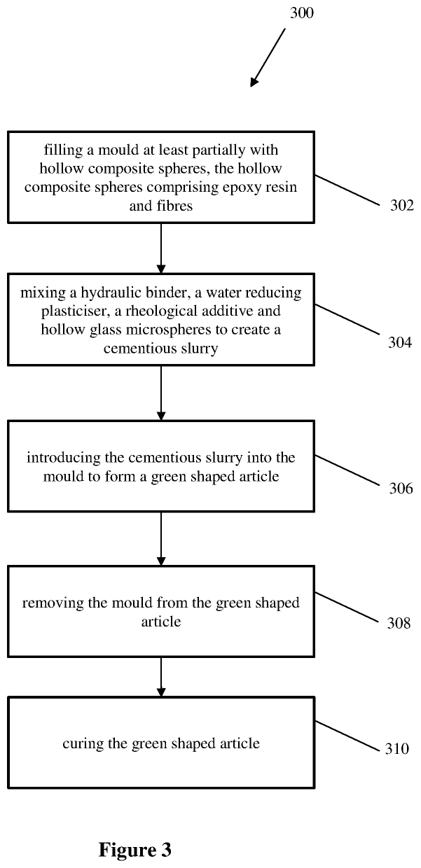

The mono or binary composite sphere light weight concrete material may be made in a number of ways. For example, one exemplary method 300 of making the material as illustrated in a flow chart in FIG. 3 includes a step of filling 302 a mould at least partially with composite spheres. For example, for composite spheres of two different diameters, the mould may initially be packed with composite spheres of the larger diameter such that minimum free space is provided within the mould. In a further step, a cementitious slurry is created by mixing 304 the hydraulic binder, the water reducing plasticiser, the rheological additive and the glass microspheres. In the above mentioned example in which composite spheres of two different diameters are provided, the composite spheres of the smaller diameter may also be mixed into the cementitious slurry. The so created cementitious slurry is then introduced 306 into the mould to fill the spaces between the composite spheres of the larger diameter such that a green shaped article is formed. In some example, the cementitious slurry including the composite spheres is left in the mould until the material has sufficient green strength. Alternatively, this curing step may be accelerated using low pressure steam. The steam may have a temperature of less than 75° C., such as less than 60° C., or less than 50° C., or less than 40° C. Additionally or alternatively, the curing step may be accelerated using a fast set concrete or chemical cure accelerators, such as lithium carbonate.

The mould can then be removed 308 and the green shaped article can be cured 310, for example air cured or accelerated such as in an autoclave at an elevated temperature. For example, if the green shaped article is air cured, the resulting concrete material may have 80% strength after approximately 14 days. If the green shaped article is cured in an accelerated way, as for example described above, the concrete material may have 80% strength after 24 hours to 7 days. It will be appreciated that the time period for the curing process depend on the particular curing process that is used.

Furthermore, the length and time chosen for curing the material is generally dependent on the formulation and the form and shape of the resulting article defined by the mould.

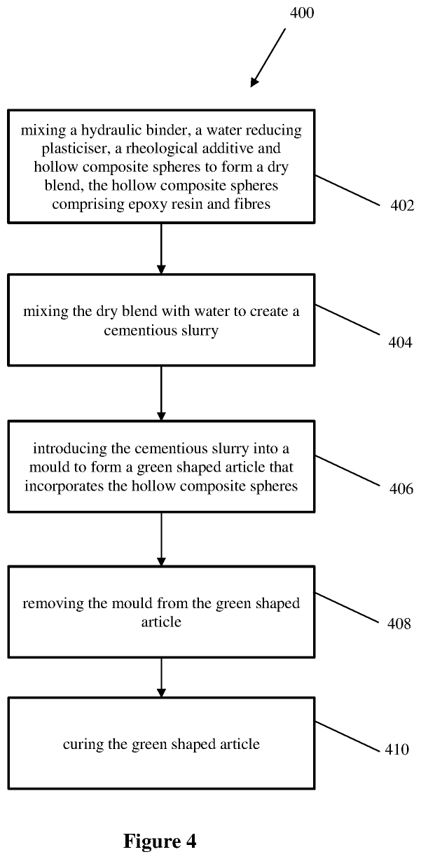

In an alternative exemplary method 400 as illustrated in a flow chart shown in FIG. 4, the method 400 comprises an initial step 402 of mixing a hydraulic binder, a water reducing plasticiser, a rheological additive and composite spheres to form a dry concrete blend. The composite spheres may for example be the composite spheres as described above.

In a next step, the dry concrete blend is mixed 404 with water to create a cementitious slurry. Similar to method 300, this cementitious slurry is introduced 406 into a mould to form a green shaped article. The mould can be removed 408 when the article has sufficient green strength and is then cured 410, for example air cured or cured in an autoclave.

One particular composition or formulation made by method 300 or 400 includes the following components by weight (% wt):

| | |
|---|---|
| Portland gp cement | 36.67% |
| Water | 27.54% |
| Glass microspheres (K25 3M) | 8.73% |
| Silica fume | 3.63% |
| Cement water reducer | 0.39% |
| Hydroxyethyl cellulose rheological additive | 0.07% |
| Concrete anti-foam | 0.13% |
| Composite spheres | 22.84% |

The composite spheres in this particular formulation may be carbon fibre composite spheres with a density of 214 kg/m³. For example, composite spheres having a core that is coated with at least one fibre layer comprising carbon fibre.

Another particular formulation made by method 300 or 400 includes the following components by weight (% wt):

| | |
|---|---|
| Portland gp cement | 21.76% |
| Water | 15.94% |
| Silica sand | 39.86% |
| Silica fume | 2.15% |
| Cement water reducer | 0.23% |
| Hydroxyethyl cellulose rheological additive | 0.04% |
| Concrete anti-foam | 0.08% |
| Composite spheres | 22.84% |

The composite spheres in this particular formulation may be mineral fibre composite spheres with a density of 470 kg/m³. For example, composite spheres having a core that is coated with at least one fibre layer comprising mineral fibre.

### Second Embodiment—A Lightweight Concrete Compound Material Suited for Construction Applications

A second embodiment of the present disclosure relates to a cement or concrete composition comprising composite spheres and ceramic microspheres. The resulting material is particularly suited for construction applications for reasons illustrated in detail below. In this particular embodiment, the concrete material can be a lightweight material having a density in a range of 600 kg/m³ to 1800 kg/m³.

Exemplary construction applications for which the concrete material of the second embodiment may be suited include structures such as lightweight precast structures, lightweight panel/flooring structures, energy absorbing materials, fire retardant panel structures, sound dampening panels and structures, thermally insulating panels and structures, and any other various structures used in construction applications.

Similar to the first embodiment, the cement or concrete composition typically comprises a hydraulic binder, a water reducing plasticiser and a rheological additive.

In addition, the resulting lightweight concrete material further comprises composite spheres, such as the composite spheres described with reference to the first embodiment, and ceramic microspheres, for example cenospheres.

Optionally, the lightweight concrete material may include a fine aggregate material.

In this particular embodiment, the cement or concrete composition comprises a hydraulic binder, a water reducing plasticiser, a rheological additive, a fine aggregate material, and ceramic microspheres, such as cenospheres.

The cement or concrete composition may for example comprise the hydraulic binder, the water reducing plasticiser and the rheological additive as described above for the first embodiment.

The fine aggregate material is typically added to the cement or concrete composition to increase the overall Young's modulus and thereby the overall strength of the resulting concrete material. Exemplary aggregate material used for this embodiment may include, but is not limited to, calcium carbonate (calcite) and silica such as silica sand. The particle size of the fine aggregate material for this embodiment may range between a diameter of approximately 200 micron to 4 mm.

The ceramic microspheres, such as cenospheres is typically added to the cementitious formulation of this particular embodiment to lower the density and improve the overall strength of the resulting concrete compound material.

Ceramic microspheres typically is natural, synthetic or a by-product. One example of ceramic microspheres are cenospheres which typically are a coal ash by-product. Ceramic microspheres are commercially available, for example, under the names fillite and cenolite. A particle size of the ceramic microspheres may range between 10 to 600 microns, such as at least 20 microns, or at least 50 microns or at least 100 microns, and/or less than 500 microns, or 400 microns or 300 microns.

The second embodiment of the present disclosure also comprises the composite spheres according to embodiments as described herein. The composite spheres may have similar or substantially identical properties as the composite spheres that are incorporated into the concrete material of the first embodiment.

By adding the hollow composite spheres into the concrete material, the density of the material can be lowered and the overall strength of the material can be increased. Furthermore, at least some of the hollow composite spheres used for the second embodiment are substantially impervious to water. This provides significant advantages in building applications, for example for building panels or structure that are exposed to humidity or wet conditions.

Similar to the first embodiment, composite spheres may be incorporated into the material that have substantially one size or two sizes and compositions. However, a person skilled in the art will appreciate that composite spheres of various sizes and compositions may be added to the concrete material depending on the desired properties of the resulting material. In one example, composite spheres of substantially one size and type are incorporated into the concrete material as schematically shown in FIG. 1. In an alternatively example, composite spheres of substantially two sizes are incorporated into the concrete material as schematically shown in FIG. 2.

An exemplary composition of the concrete material of the second embodiment of the present disclosure includes approximately (by volume) 30-50% composite spheres, 0-40% cenospheres, 0-40% fine aggregate material, such as silica sand of 1-3 mm, 5-50% hydraulic binder, 0.05-3% cement water reducer, and 0.05-3% rheological additive.

The concrete material of the second embodiment may be made in a similar manner as the first embodiment with reference to exemplary methods 300 and 400. In other words, a mould may be packed with at least one type of composite spheres and the remaining components may be mixed with water to create a slurry that is introduced into the mould where a green shaped article can be formed. Alternatively, the material components may be mixed to form a dry blend that is subsequently mixed with water and introduced into a mould.

### Method of Making a Lightweight Concrete Compound Material as Described for the First and Second Embodiments

In the following, exemplary methods for manufacturing the above described lightweight concrete material will be described.

A first example method relates to a method of manufacturing a mono composite sphere concrete material. In this particular example, composite spheres of substantially one diameter and one density are provided. A closed mould is filled with the composite spheres such that minimum free space is provided between the composite spheres. The mould may for example be lined with a reinforcing material. However, this reinforcing material is optional. Also, the core of the mould may comprise additional reinforcing material. However, this reinforcing material is optional.

Following the step of filling the mould with the hollow composite spheres, a cementitious formulation which may also referred to as a grout is prepared by mixing water to the remaining components that are described above with reference to the first and second embodiments. As described above, the remaining components may include hydraulic binder, such as Portland cement, water reducing plasticiser, a rheological additive and micro glass spheres. The hydraulic binder may for example be selected to have relatively high flow characteristics when mixed with water.

Following preparation of the cementitious formulating, the formulation is introduced into the mould, for example by use of pump and suitable injection manifold.

In this example, it is preferable to inject the formulation into the mould via a manifold at the lowest possible point of the mould. However, it will be appreciated that depending on the flow characteristics of the cementitious formulation, the formulation may alternatively be introduced at the head of the mould.

Following injection of the cementitious formulation into the mould, the mould is left for a time period specific to the material formulation to allow the green strength of the concrete material to build to a level sufficient for the mould to be removed. In a further step, the mould is removed and the concrete material is cured to reach an optical strength. The concrete material may for example be air cured or cured in an autoclave.

A second example method relates to a method of manufacturing a binary composite sphere concrete material. In this particular example, composite spheres are provided having two different diameters. In a first step, a closed mould is filled with the composite spheres in a way to minimise overall percentage of free space between the composite spheres. This may for example be achieved by using composite spheres of maximum possible diameter ratio. However, it will be appreciated that the maximum possible ratio may not be practical for certain applications. In order to achieve minimised overall percentage of free space between the composite spheres, a volume ratio of the composite spheres in the formulation needs to be determined. Exemplary volume ratios for two sized hollow composite spheres may be in a range between 2:1 to 3.5:1 (large:small ratio).

Following the step of filling the mould with the composite spheres of both diameters, the cementitious formulation can be mixed and the material can be processed and cured as described with reference to the first example method above.

A third example method relates to an alternative method of making the mono or binary composite concrete compound material. In this particular example, the composite spheres are mixed with the remaining components such as the hydraulic binder, the water reducing plasticiser and the rheological additive to form a dry blend of material components. In other words, at this step, no water is mixed with the components.

For example, the composite spheres may have any suitable number of different diameters and densities and may be added to the remaining components at a level of 10% to 60% by volume, such as at least (in %) 20, 30, 40, or 50, or less than 60, 50, 40, 30, or 20, or any range therebetween, for example between about 30% to 50%. The resultant dry blend may also be referred to as a syntactic concrete dry blend. Mixing the components to form a dry blend has the advantage that the formulations may be stored in sealed bags for prolonged periods.

In a further step, the dry blend material may be added to a conventional concrete mixer and water added to produce a syntactic concrete slurry. The concrete slurry may be poured onto a shuttered or moulded surface and may or may not be ‘self-compacting. The resulting concrete compound material is then left for a predetermined time period to allow the green strength of the concrete material to build. The mould can then be removed and the material is allowed to cure to reach an optimal strength.

A fourth example method relates to a method of making a binary composite spheres concrete compound material. In this particular example, composite spheres of two different diameters are provided.

In a first step, the larger composite spheres of, for example, 20-100 mm diameter are introduced into a closed mould. The mould may or may not be lined with a reinforcing material and the core of the mould may or may not include additional reinforcing material.

The remaining components, such as the hydraulic binder, the water reducing plasticiser and the rheological additive, are mixed with the smaller composite spheres to form a dry blend. The smaller composite spheres may for example have a diameter of 1-15 mm. In this particular step, no water is mixed with the material components. The spheres are added to the dry grout at a level of 10% to 60% by volume, such as at least (in %) 20, 30, 40, or 50, or less than 60, 50, 40, 30, or 20, or any range therebetween, for example between about 30% to 50%.

The resultant dry blend may also be referred to as a syntactic concrete dry blend and may be stored in sealed bags for prolonged periods.

The dry blend material may be added to a conventional concrete mixer and water added to produce a syntactic concrete slurry. The slurry is then introduced into the mould, for example by use of pump and suitable injection manifold. During injection of the slurry, the slurry will flow through the voids in between the larger composite spheres in order to produce a substantially void free wet syntactic concrete.

Following injection of the slurry into the mould, the mould is left for a predetermined time period to allow the green strength of the concrete material to build. The mould can then be removed and the concrete compound material is cured to reach an optimal strength.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. However, in alternative embodiments the term “comprise” may be replaced with the term “consisting of” or “consisting essentially of” where for some embodiments or examples an alternative more exclusive context is desired.

1. A cement or concrete composition comprising a hydraulic binder, a water reducing plasticiser, a rheological additive, and composite spheres for lowering the density of the composition, wherein each of the composite spheres comprises a core having one or more coating layers thereon, and wherein the one or more coating layers on a core are independently selected from at least one of a fibre layer, aggregate layer and cement layer.

2. The cement or concrete composition of claim 1, wherein each of the composite spheres comprise at least a first coating layer on the core selected from one or more fibre layers, and a subsequent or outer coating layer on the core selected from at least one of an aggregate layer and a cement layer.

3. The cement or concrete composition of claim 1 or claim 2, wherein each of the one or more coating layers of the composite spheres comprises a polymer with a fibre, aggregate or cement material.

4. The cement or concrete composition of claim 3, wherein the polymer comprises an epoxy resin and optionally an amine hardener.

5. The cement or concrete composition of any one of claims 1 to 4, wherein the composition comprises 40-65% by volume of the composite spheres.

6. The cement or concrete composition of any one claims 1 to 5, wherein the composition comprises 5-50% by volume of the hydraulic binder, 0.05-3% by volume of the water reducing plasticiser, and 0.05-3% by volume of the rheological additive.

7. The cement or concrete composition of any one of the preceding claims, wherein the composition comprises composite spheres of substantially uniform size and composition.

8. The cement or concrete composition of any one of the preceding claims, wherein a diameter of the composite spheres is between 1 mm and 100 mm.

9. The cement or concrete composition of any one of the preceding claims, wherein the composition comprises at least a first and second type of composite spheres each having different size ranges, wherein the first type of composite spheres have a diameter of between 25 to 100 mm and the second type of composite spheres have a diameter of 1 to 10 mm.

10. The cement or concrete composition of claim 9, wherein a diameter ratio between the first type of composite spheres and second type of composite spheres is less than 4:1.

11. The cement or concrete composition of any one of the preceding claims, wherein the core comprises a polymer core.

12. The cement or concrete composition of any one of the preceding claims, wherein the polymer core of the composite spheres is expanded polystyrene.

13. The cement or concrete composition of any one of the preceding claims, further comprising glass microspheres.

14. The cement or concrete composition of any one of the preceding claims, further comprising ceramic microspheres.

15. The cement or concrete composition of claim 14, wherein the concrete composition comprises less than 40% by volume of the ceramic microspheres.

16. The cement or concrete composition of any one of the preceding claims, further comprising a fine aggregate material.

17. The cement or concrete composition of claim 16, wherein the fine aggregate material comprises at least one of silica and calcium carbonate having a particle diameter of between 200 microns to 4 mm.

18. The cement or concrete composition of any one of the preceding claims, wherein the composition is a dry blend composition for preparing a low density concrete.

19. A concrete material prepared from or comprising the composition or an admixture of the composition of any one of the preceding claims and water.

20. The concrete material of claim 19, wherein the composition comprises the ceramic microspheres, and the density of the concrete is between 600 kg/m³ to 1800 kg/m³.

21. The concrete material of claim 19, wherein the composition comprises glass microspheres and the density of the concrete is between 300 kg/m³ to 800 kg/m³.

22. A plurality of composite spheres for use in lowering the density of a concrete material, wherein each composite sphere comprises a core having one or more coating layers thereon, the one or more coating layers each independently selected from a coating layer comprising a polymer with at least one of a fibre, aggregate or cement.

23. The composite spheres of claim 22, wherein the polymer in the coating layers comprises an epoxy resin and optionally an amine hardener.

24. The composite spheres of claim 22 or claim 23, wherein at least a first coating layer on the core of a composite sphere is selected from one or more fibre layers, and a subsequent or outer coating layer on the same core is selected from at least one of an aggregate layer and a cement layer.

25. The composite spheres of any one of claims 22 to 24, wherein the composite spheres each comprise at least four coating layers having one or more first coating layer(s) being a fibre layer, one or more second coating layers being an aggregate layer, one or more third coating layers being a fibre layer, and one or more forth coating layers being a cement layer.

26. Use of composite spheres in a cement or concrete composition for lowering the density of a concrete material prepared therefrom, wherein the composite spheres are defined according to any one of claims 22 to 25.

27. A method of preparing a concrete material comprising incorporating composite spheres with a cement formulation to form the concrete material, wherein the composite spheres are defined according to any one of claims 22 to 25.

28. A method of forming a concrete material, the method comprising:
mixing at least a hydraulic binder, a water reducing plasticiser, a rheological additive and water to create a slurry;
providing a mould;
filling the mould at least partially with composite spheres, wherein the composite spheres are defined according to any one of claims 22 to 25;
introducing the slurry into the mould that is at least partially filed with the composite spheres to form a green shaped article;
removing the mould from the green shaped article; and
curing the green shaped article to form the concrete material.

29. A method of forming a concrete material, the method comprising mixing the cement or concrete composition according to any one of claims 1 to 18 with water to form a slurry, and allowing the slurry to cure into a concrete material.

30. The method of claim 29, the method further comprising introducing the slurry into a mould to form a green shaped article, removing the mould from the green shaped article, and curing the green shaped article to form the concrete material.
